(19) United States
(12) Patent Application Publication
(10) Pub. No.: US 2005/0200566 A1
(43) Pub. Date: Sep. 15, 2005

(54) Driving apparatus of plasma display panel

(76) Inventors: Jin-Sung Kim, Suwon-si (KR); Woo-Joon Chung, Suwon-si (KR); Seung-Hun Chae, Suwon-si (KR)

Correspondence Address: MCGUIREWOODS, LLP, 1750 TYSONS BLVD, SUITE 1800, MCLEAN, VA, 22102, US

(21) Appl. No.: 11/075,868

(22) Filed: Mar. 10, 2005

(30) Foreign Application Priority Data
Mar. 11, 2004 (KR) 10-2004-0016440

(51) Int. Cl. G09G 3/28

(52) U.S. Cl. 345/60

(57) ABSTRACT

A driving apparatus of a plasma display panel. In a scan electrode driving circuit, a drain of a first transistor is coupled to a scan electrode, and a driver of the first transistor is coupled to the gate and a source of the first transistor. During a reset period, the driver turns on the first transistor and reduces a voltage at a scan electrode and then turns off the first transistor so as to gradually reduce the voltage of the scan electrode by floating the scan electrode. Further, a selecting voltage may be applied to the scan electrode by turning on the first and second transistors during an address period. Thus, the transistor used during the reset period may be used in the address period.

### CROSS REFERENCE TO RELATED APPLICATION

This application claims priority to and the benefit of Korean Patent Application No. 10-2004-0016440, filed on Mar. 11, 2004, which is hereby incorporated by reference for all purposes as if fully set forth herein.

### BACKGROUND OF THE INVENTION

1. Field of the Invention

The present invention relates to a driving apparatus of a plasma display panel (PDP), and more particularly, the present invention relates to a circuit for driving a scan electrode of the PDP.

2. Discussion of the Background

Generally, a PDP uses plasma generated by gas discharge to display characters or images, and it may include more than several tens of thousands to millions of pixels arranged in a matrix. A PDP may be classified as a direct current (DC) type or an alternating current (AC) type according to driving voltage waveforms and discharge cell structures.

When driving the AC PDP, a unit frame may be divided into a plurality of subfields for time division gray scale display, and each subfield may include a reset period, an address period, and a sustain period.

In the reset period, wall charges formed by a previous sustain-discharge may be erased, and each cell is initialized to stably perform a subsequent addressing operation. In the address period, each cell is selected to be turned on or turned off, and wall charges accumulate in the cells that are selected to be turned on (i.e., addressed cells). In the sustain period, a sustain discharge waveform may be alternately applied to a scan electrode and a sustain electrode to cause a discharge that displays an image on the addressed cell.

Conventionally, a ramp waveform may be applied to a scan electrode to establish wall charges in the reset period, as shown in FIG. 1 and disclosed in U.S. Pat. No. 5,745,086. In other words, a gradually rising ramp waveform may be applied to the scan electrode, followed by a gradually falling ramp waveform. In this case, since an ability to precisely control the wall charges may significantly depend on the gradient of the ramp, the wall charges may not be precisely controlled within a predetermined time frame.

Further, although a final voltage V_{nf} of the ramp falling waveform and a voltage V_{scl} applied to a selected scan electrode during the address period may be the same, separate transistors may be used for respectively transmitting the voltages V_{nf} and V_{scl}. In other words, a driver may have to be coupled to a contact of the scan electrode and to the transistor, which may be incapable of applying the pulse type voltage V_{nf}. Thus, separate transistors may be necessary: one for transmitting the voltage V_{nf}, and the other for the transmitting the voltage V_{scl}.

### SUMMARY OF THE INVENTION

The present invention provides a driving apparatus to control wall charges within a predetermined time.

Further, the present invention may use a same transistor during a reset period and an address period.

Additional features of the invention will be set forth in the description which follows, and in part will be apparent from the description, or may be learned by practice of the invention.

The present invention discloses a driving apparatus of a plasma display panel having a capacitive load formed by at least two electrodes. The driving apparatus includes a first transistor having a first main end coupled to a first electrode of the capacitive load, a capacitor having a first end coupled to a second main end of the first transistor and a second end coupled to a first power supplying a first voltage so as to receive charges from the capacitive load when the first transistor is turned on. A second transistor is coupled between the second main end of the first transistor and a second power supplying a second voltage. A voltage of the first electrode is reduced by repeatedly turning the first transistor on and off during a reset period. The first transistor and the second transistor are turn on during the address period so as to apply the second voltage to the first electrode.

The present invention also discloses a driving apparatus of a plasma display panel having a capacitive load formed by at least two electrodes. The driving apparatus includes a first transistor having a first main end coupled to a first electrode of the capacitive load, a driver coupled between a control end and a second main end of the first transistor and a first power supplying a first voltage, and a second transistor coupled between the second main end of the first transistor and a second power supplying a second voltage. The driver controls an operation of the first transistor to gradually reduce a voltage at the first electrode during a reset period. The second voltage is supplied to the first electrode when the first transistor and the second transistor are turned on during an address period

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows a conventional driving waveform of a PDP.

FIG. 2 is a schematic view of a PDP according to an exemplary embodiment of the present invention.

FIG. 3 is a driving waveform of the PDP according to an exemplary embodiment of the present invention.

FIG. 4 shows a voltage of an electrode and a discharge current in response to the driving waveform of FIG. 3.

FIG. 5A is a modeled diagram showing a discharging cell formed by a sustain electrode and a scan electrode.

FIG. 5B shows an equivalent circuit of FIG. 5A.

FIG. 5C shows a state in which a voltage is applied when a discharge is not occurring in the discharging cell of FIG. 5A.

FIG. 5D shows a state in which a voltage is applied when a discharge is occurred in the discharging cell of FIG. 5A.

FIG. 5E shows a floating state when a discharge is occurring in the discharging cell of FIG. 5A.

FIG. 6 is a schematic circuit diagram according to a first exemplary embodiment of the present invention.

FIG. 7 is a driving waveform diagram for the driving circuit of FIG. 6.

FIG. 8 and FIG. 9 are schematic circuit diagrams according to second and third exemplary embodiments of the present invention, respectively.

FIG. 10 and FIG. 11 are scan electrode diving circuit diagrams according to fourth and fifth exemplary embodiments of the present invention, respectively.

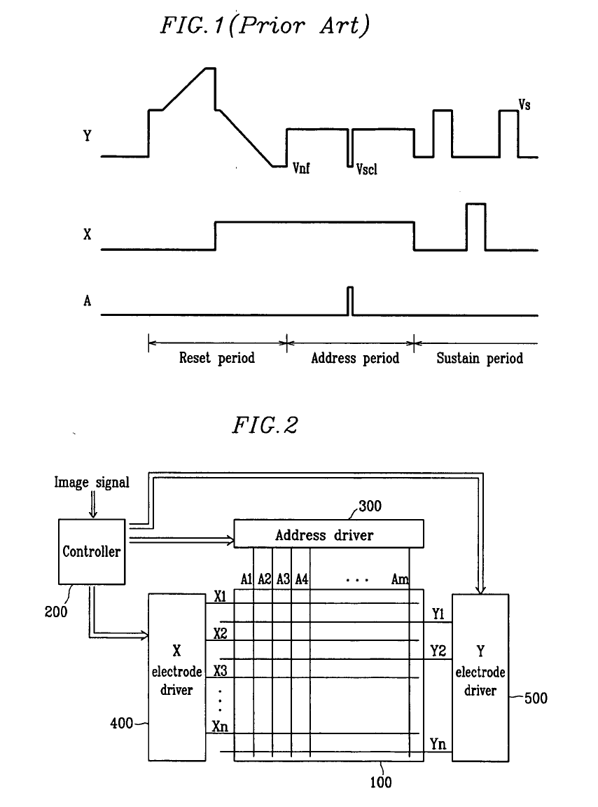

### DETAILED DESCRIPTION OF THE ILLUSTRATED EMBODIMENTS

In the following detailed description, exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, rather than restrictive.

In the drawings, illustrations of elements having no relation with the present invention are omitted in order to more clearly present the subject matter of the present invention. In the specification, the wall charges refer to charges that accumulate to the electrodes and are formed proximately to the respective electrodes on the wall (e.g., dielectric layer) of the discharge cells. The wall charges do not actually touch the electrodes themselves, but they may be described herein as being “formed on”, “stored on”, and/or “accumulated to” the electrodes.

A driving apparatus of a PDP according to an exemplary embodiment of the present invention will be described in detail hereinafter with reference to the annexed drawings.

FIG. 2 schematically shows a plasma display device according to an exemplary embodiment of the present invention.

Referring to FIG. 2, the plasma display device may include a plasma display panel (PDP) 100, a controller 200, an address driver 300, a sustain (X) electrode driver 400, and a scan (Y) electrode driver 500.

The PDP 100 may include address electrodes A₁ to Aₘ arranged in columns, and pairs of sustain electrodes X₁ to Xₙ and scan electrodes Y₁ to Yₙ alternately arranged in rows. Ends of the sustain electrodes X₁ to Xₙ may be coupled together. Additionally, the PDP 100 may include a substrate (not shown) on which the sustain electrodes and the scan electrodes are arranged, and a substrate (not shown) on which the address electrodes are arranged. These substrates are sealed together and define a discharge space therebetween, and the address electrodes A₁ to Aₘ may be orthogonal to the scan electrodes Y₁ to Yₙ and the sustain electrodes X₁ to Xₙ. A discharge cell may be formed at a portion of the discharge space corresponding to an intersection of an address electrode and a scan and sustain electrode pair.

The controller 200 receives an external image signal and outputs a sustain electrode driving control signal, a scan electrode driving control signal, and an address driving control signal. Further, the controller 200 may divide a single frame into a plurality of sub-fields, where a subfield may include a reset period, an address period, and a sustain period with respect to temporal variations in operations.

The address driver 300 receives the address driving control signal from the controller 200 and transmits a data signal to the address electrodes A1 to Am to select desired discharge cells. The X electrode driver 400 and the Y electrode driver 500 receive the sustain and scan electrode driving control signals from the controller 200 and apply driving voltages to the sustain and scan electrodes, respectively.

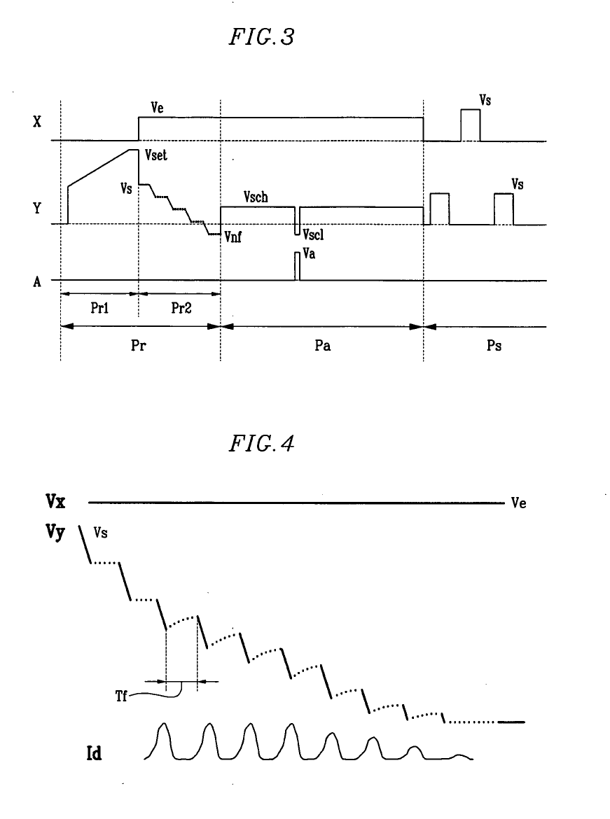

Hereinafter, a driving waveform that may be applied to the address electrodes A1 to Am, the sustain electrodes X1 to Xn, and the scan electrodes Y1 to Yn will be described with reference to FIG. 3 and FIG. 4. A discharge cell formed by an address electrode, a sustain electrode, and a scan electrode will also be described below.

FIG. 3 shows a driving waveform of the PDP according to an exemplary embodiment of the present invention, and FIG. 4 shows a voltage of a Y electrode and a discharge current with respect to the driving waveform of FIG. 3.

As shown in FIG. 3, a subfield may include a reset period Pᵣ, an address period Pₐ, and a sustain period Pₛ, and the reset period Pᵣ may include a rising period Pᵣ₁ and a falling period Pᵣ₂.

Generally, positive charges may be formed on the sustain electrode, and negative charges may be formed on the scan electrode when the last sustain-discharge finishes in the sustain period. In the rising period Pᵣ₁ of the reset period Pr, a waveform gradually rising from a voltage of Vₛ to a voltage of Vₛₑₜ may be applied to the scan electrode while biasing the sustain electrode at 0V. During this period, a weak reset discharge may occur from the scan electrode to the address electrode and the sustain electrode, respectively, thus accumulating positive wall charges on the scan electrode and negative wall charges on the address electrode and the sustain electrode.

As shown in FIG. 3 and FIG. 4, in the falling period Pᵣ₂ of the reset period Pᵣ, the voltage applied to the scan electrode may decrease by a predetermined voltage, and then the scan electrode may be floated, during a period T_{f}, by stopping the voltage applied thereto, while biasing the sustain electrode at the voltage of Vₑ. This process of reducing the voltage applied to the scan electrode and floating the scan electrode may be repeated.

When a difference between the voltage of Vₓ at the sustain electrode and the voltage of V_{y} at the scan electrode exceeds a discharge firing voltage V_{f}, a discharge may occur between the sustain and scan electrodes. In other words, a discharge current I_{d} flows through the discharging space. Floating the scan electrode after starting the discharge changes the voltage at the scan electrode on the basis of the amount of wall charges because an electric charge is not supplied from an external power source. Accordingly, the changed amount of the wall charge may reduce the voltage within the discharge space, thus quenching the discharge with a small amount of wall charges. In other words, the wall charges formed on the sustain electrode and the scan electrodes may rapidly reduce the voltage in the discharge space so that an intense discharge quenching may occur. When the scan electrode is floated after its voltage has fallen to create a discharge, the wall charges may be reduced and the intense discharge quenching may also be generated within the discharge space. Repeatedly reducing the voltage of the scan electrode and then floating it may form desired wall charges on the sustain and scan electrodes.

As described above, the discharge may be quenched with a smaller amount of wall charges to more precisely control the wall charges. Further, a conventional reset method of applying a gradually falling ramp waveform may slowly decrease the voltage at the scan electrode to prevent an intense discharge and control the wall charges. Since the gradient of the ramp waveform may control discharge intensity, acceptable values of the gradient may be restricted, which may increase the amount of time for carrying out the reset operation. Contrarily, a reset method, using the floating state, according to an exemplary embodiment of the present invention may control the intensity of the discharge using a voltage drop based on the wall charge, which may reduce the time required for the reset period.

The time for reducing the voltage at the scan electrode should not be so long that it causes an excessively intense discharge. Therefore, the time for applying a voltage to the scan electrode may be shorter than the time for floating the scan electrode.

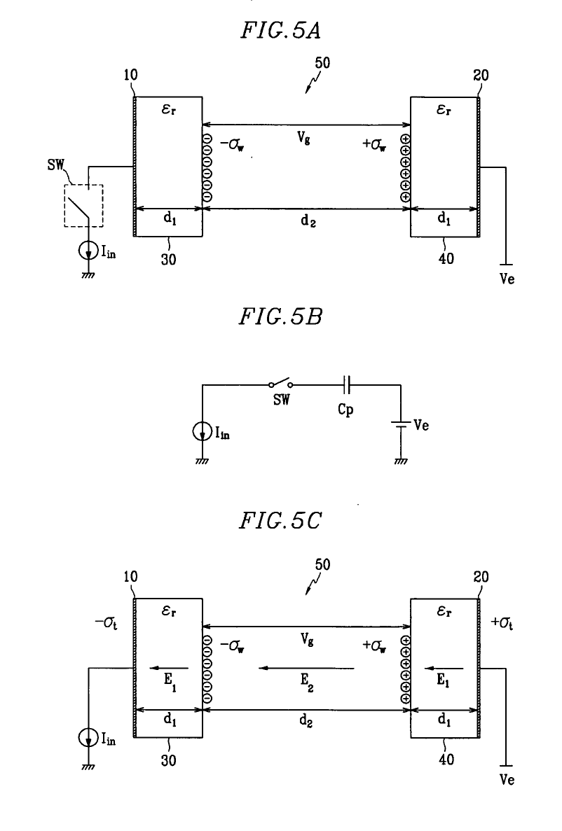

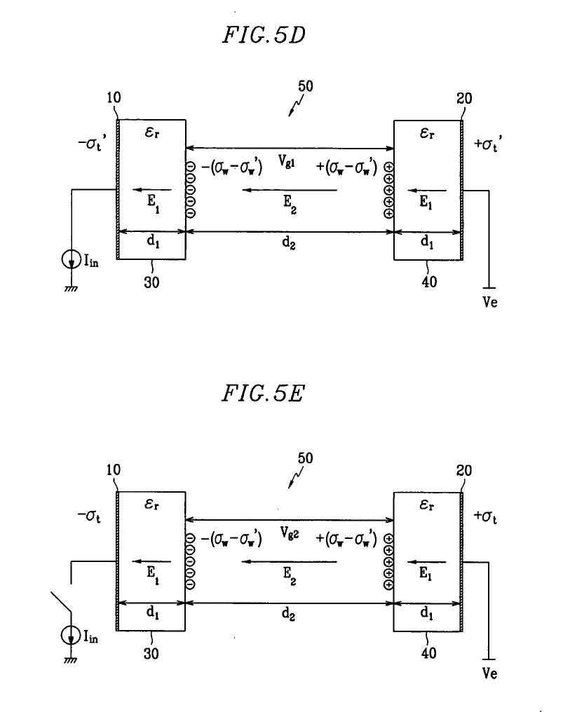

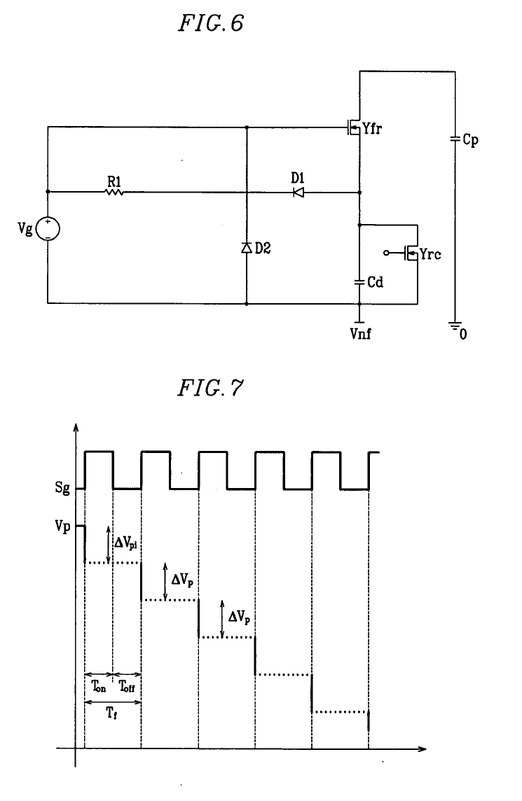

Referring to FIG. 5A, FIG. 5B, FIG. 5C, FIG. 5D and FIG. 5E, the intense discharge quenching that may be caused by floating will be described hereinafter with reference to the sustain and scan electrodes in the discharge cell, since the discharge generally occurs therebetween.

FIG. 5A is a modeled diagram showing a discharge cell formed by a sustain electrode and a scan electrode, and FIG. 5B shows an equivalent circuit of FIG. 5A. FIG. 5C shows a case when no discharge occurs in the discharge cell of FIG. 5A, FIG. 5D shows a state in which a voltage is applied when a discharge occurs in the discharge cell, and FIG. 5E shows a floated state when a discharge occurs in the discharge cell. For ease of description, charges −σ_{w} and +σ_{w} are respectively formed at the scan electrode and the sustain electrode 10 and 20 in an earlier stage in FIG. 5A. The charges are formed on a dielectric layer of an electrode, but for ease of explanation, it is described that the charges are formed at the electrode.

As shown in FIG. 5A, the scan electrode 10 is coupled to a current source Iᵢₙ through a switch SW, and the sustain electrode 20 is coupled to the voltage of Vₑ. Dielectric layers 30 and 40 are respectively formed covering the scan electrode 10 and the sustain electrode 20. Discharge gas (not shown) is injected between the dielectric layers 30 and 40, and the area provided between the dielectric layers 30 and 40 forms a discharge space 50.

Since the scan and sustain electrodes 10 and 20, the dielectric layers 30 and 40, and the discharge space 50 form a capacitive load, they may be represented as a panel capacitor Cₚ, as shown in FIG. 5B. In FIG. 5A, εᵣ is the dielectric constant of the dielectric layers 30 and 40, V_{g} is a voltage at the discharge space 50, d₁ is the thickness of the dielectric layers 30 and 40, and d₂ is the distance between the dielectric layers 30 and 40 (the width of the discharge space).

The voltage of V_{y} applied to the scan electrode of the panel capacitor Cp decreases in proportion to time when the switch SW is turned on, as given in Equation 1. That is, when the switch SW turns on, the scan electrode voltage V_{y} decreases. In FIGS. 5A to 5E, the voltage at the scan electrode is reduced by using the current source Iᵢₙ. However, the voltage at the scan electrode may be reduced by directly applying a reduced amount of voltage to the scan electrode or discharging the panel capacitor Cₚ.

$${V}_{y} = {V}_{y} ( 0 ) - \frac{{I}_{i n}}{{C}_{p}} t \qquad Equation 1$$

where V_{y}(0) is a scan electrode voltage V_{y} when the switch SW turns on, and Cₚ is the capacitance of the panel capacitor Cₚ.

Referring to FIG. 5C, the voltage V_{g}, applied to the discharge space 50 when no discharge occurs while the switch SW is turned on, may be calculated, assuming that the voltage applied to the scan electrode 10 is Vᵢₙ.

When the voltage of Vᵢₙ is applied to the scan electrode, the charges −σₜ may be applied to the scan electrode 10, and the charges +σₜ may be applied to the sustain electrode 20. By applying the Gaussian theorem, the electric field E₁ within the dielectric layers 30 and 40 and the electric field E₂ within the discharge space 50 may be given as Equations 2 and 3.

$${E}_{1} = \frac{{σ}_{t}}{{ɛ}_{r} {ɛ}_{0}} \qquad Equation 2$$

where σₜ is charges applied to the scan electrode and the sustain electrode, and ε₀ is a permittivity within the discharge space.

$${E}_{2} = \frac{{θ}_{t} + {σ}_{w}}{{ɛ}_{0}} \qquad Equation 3$$

The voltage of (Vₑ−Vᵢₙ) applied outside the discharge space may be given as Equation 4 according to a relation between electric fields and distances, and the voltage of V_{g} of the discharge space 50 may be given as Equation 5.
2d₁E₁+d₂E₂=Vₑ−Vᵢₙ Equation 4
V_{g}=d₂E₂ Equation 5

From Equations 2, 3, 4 and 5, the charges σₜ applied to the scan electrode 10 or the sustain electrode 20, and the voltage V_{g} within the discharge space 50, may be respectively given as Equations 6 and 7.

$${σ}_{t} = \frac{{V}_{e} - {V}_{i n} - \frac{{d}_{2}}{{ɛ}_{0}} {σ}_{w}}{\frac{{d}_{2}}{{ɛ}_{0}} + \frac{2 {d}_{1}}{{ɛ}_{r} {ɛ}_{0}}} = \frac{{V}_{e} - {V}_{i n} - {V}_{w}}{\frac{{d}_{2}}{{ɛ}_{0}} + \frac{2 {d}_{1}}{{ɛ}_{r} {ɛ}_{0}}} \qquad Equation 6$$

where V_{w} is a voltage formed by the wall charges σ_{w} in the discharge space 50.

$${V}_{g} = \frac{{ɛ}_{r} {d}_{2}}{{ɛ}_{r} {d}_{2} + 2 {d}_{1}} ( {V}_{e} - {V}_{i n} - {V}_{w} ) + {V}_{w} = α ( {V}_{e} - {V}_{i n} ) + ( 1 - α ) {V}_{w} \qquad Equation 7$$

Actually, since the widht d₂ of the discharge space 50 is a very large value compared to the thickness d₁ of the dielectric layers 30 and 40, α almost reaches 1. That is, Equation 7 shows that the externally applied voltage of (Vₑ−Vᵢₙ) may be applied to the discharge space 50.

Referring to FIG. 5D, the voltage V_{g1} within the discharge space 50 may be calculated when the wall charges formed at the scan electrode 10 and the sustain electrode 20 are quenched by the amount of σ_{w}′ because of the discharging caused by the externally applied voltage of (Vₑ−Vᵢₙ). The charges applied to the scan electrode and the sustain electrode 20 may increase to σₜ′ since the power Vᵢₙ supplies the charges to maintain the potential of the electrodes when the wall charges are formed.

By applying the Gaussian theorem in FIG. 5D, the electric field E₁ within the dielectric layers 30 and 40 and the electric field E2 within the discharge space 50 may be given is as Equation 8 and 9.

$$\begin{matrix}{E}_{1} = \frac{{σ}_{t}^{′}}{{ɛ}_{r} {ɛ}_{0}} & Equation 8 \\ {E}_{2} = \frac{{σ}_{t}^{′} + {σ}_{w} - {σ}_{w}^{′}}{{ɛ}_{0}} & Equation 9\end{matrix}$$

From Equations 8 and 9, the charges σₜ′ applied to the scan electrode 10 and the sustain electrode 20, and the voltage V_{g1} within the discharge space, may be given as Equations 10 and 11.

$$\begin{matrix}{σ}_{t}^{′} = \frac{{V}_{e} - {V}_{i n} - \frac{{d}_{2}}{{ɛ}_{0}} ( {σ}_{w} - {σ}_{w}^{′} )}{\frac{{d}_{2}}{{ɛ}_{0}} + \frac{2 {d}_{1}}{{ɛ}_{r} {ɛ}_{0}}} = \frac{{V}_{e} - {V}_{i n} - {V}_{w} + \frac{{d}_{2}}{{ɛ}_{0}} {σ}_{w}^{′}}{\frac{{d}_{2}}{{ɛ}_{0}} + \frac{2 {d}_{1}}{{ɛ}_{r} {ɛ}_{0}}} & Equation 10 \\ {V}_{g1} = {d}_{2} {E}_{2} = α ( {V}_{e} - {V}_{i n} ) + ( 1 - α ) {V}_{w} - ( 1 - α ) \frac{{d}_{2}}{{ɛ}_{0}} {σ}_{w}^{′} & Equation 11\end{matrix}$$

Since α is almost 1 in Equation 11, a small voltage decrease may be generated within the discharge space 50 when applying the voltage Vᵢₙ to generate a discharge. Therefore, when the amount σ_{w}′ of the wall charges reduced by the discharge is high, the voltage V_{g1} within the discharge space 50 decreases, and the discharge is quenched.

Referring to FIG. 5E, the voltage V_{g2} within the discharge space 50 may be calculated. Here, the switch SW is turned off (i.e., the discharge space 50 is floated) after the wall charges formed at the scan and sustain electrodes 10 and 20 are quenched by the amount of σ_{w}′ because of the discharge caused by the externally applied voltage Vᵢₙ. Since no external charge is applied, the charges applied to the scan and sustain electrodes 10 and 20 become σₜ in the same manner of FIG. 5C. By applying the Gaussian theorem, the electric field E₁ within the dielectric layers 30 and 40 and the electric field E₂ within the discharge space 50 may be given as Equation 2 and 12.

$${E}_{2} = \frac{{σ}_{t} + {σ}_{w} - {σ}_{w}^{′}}{{ɛ}_{0}} \qquad Equation 12$$

From Equations 12 and 6, the voltage V_{g2} of the discharge space 50 may be given as Equation 13.

$${V}_{g2} = {d}_{2} {E}_{2} = α ( {V}_{e} - {V}_{i n} ) + ( 1 - α ) {V}_{w} - \frac{{d}_{2}}{{ɛ}_{0}} {σ}_{w}^{′} \qquad Equation 13$$

Equation 13 shows that the quenched wall charges may generate a significant voltage decrease when the switch SW is turned off (floated). That is, as Equations 12 and 13 show, the voltage falling intensity caused by the wall charges in the floated state of the electrode may be 1/(1−α) times larger than that of the voltage applying state. Consequently, since the voltage within the discharge space 50 may be substantially reduced in the floated state when a small amount of charges decrease, the voltage between the electrodes becomes less than the discharge firing voltage, and the discharge may be steeply quenched. That is, the operation of floating the electrode after starting the discharge may function as an intense discharge quenching mechanism. When the voltage within the discharge space 50 decreases, as shown in FIG. 4, the is voltage V_{y} at the floated scan electrode increases by a predetermined voltage since the sustain electrode is fixed at the voltage of Vₑ.

Referring to FIG. 4, floating the scan electrode when the scan electrode voltage falls to cause a discharge, quenches the discharge with a slight reduction in wall charges formed at the scan and sustain electrodes, according to the discharge quenching mechanism. Repearing this operation may erase the wall charges formed at the scan and sustain electrodes step by step, thereby controlling the wall charges to reach a desired state. That is, the wall charges may be accurately controlled in the falling period Pᵣ₂ of the reset period Pᵣ to achieve a desired wall charge state.

The exemplary embodiment of the present invention is described during the falling period Pᵣ₂ of the reset period Pᵣ, but the present invention is not restricted thereto. It may be applicable to cases of controlling the wall charges by using the falling waveform.

Referring to FIG. 6 and FIG. 7, a driving circuit for generating a falling waveform will be described. This driving circuit may be formed as part of the Y electrode driver 500 of FIG. 2.

FIG. 6 is a brief circuit diagram showing the driving circuit according to a first exemplary embodiment of the present invention, and FIG. 7 is a driving waveform diagram showing driving signals that may be applied to the driving circuit of FIG. 6. Referring to FIG. 6, a panel capacitor Cₚ represents a capacitive load between the scan and sustain electrode as shown in FIG. 5A. It is assumed that a ground voltage is applied to a second end of the panel capacitor Cₚ, (i.e., the sustain electrode), and the panel capacitor Cₚ is charged with a predetermined amount of charges.

As shown in FIG. 6, the driving circuit according to the first exemplary embodiment may include transistors Y_{fr} and Y_{rc}, a capacitor C_{d}, a resistor R₁, diodes D₁ and D₂, and a control signal voltage source V_{g}. The capacitor C_{d}, the resistor R₁, the diodes D₁ and D₂, and the control signal voltage source V_{g} may be driven by a driver that drives the transistor Y_{fr}, and the voltage of the scan electrode may fall by operation of the driver, as shown in FIG. 3 and FIG. 4.

In FIG. 6, the transistors Y_{fr} and Y_{rc} are depicted as n channel MOSFETs. However, other switching elements performing similar functions may be used instead of the transistors Y_{fr} and Y_{rc}. A drain, which is one of two main ends of the transistor Y_{fr}, may be coupled to the scan electrode, which is a first end of the panel capacitor Cₚ, and a source, which is the other main end of the transistor Y_{fr}, may be coupled to a first end of the capacitor C_{d}. A second end of the capacitor C_{d} may be coupled to a power V_{nf} supplying the voltage of V_{nf}. The control signal voltage source V_{g} may be coupled between a gate, which is a control end of the transistor Y_{fr}, and the power V_{nf}, and it supplies a control signal S_{g} to the transistor Y_{fr}.

The diode D₁ and the resistor R₁ may be coupled between the first end of the capacitor C_{d} and the control signal voltage source V_{g}, and they may form a discharging path for the capacitor C_{d}. The diode D₂ may be coupled between the power V_{nf} and the gate of the transistor Y_{fr}, and it clamps the gate voltage of the transistor Y_{fr}. In other words, the transistor Y_{fr} may be coupled to the capacitor C_{d} in parallel. A resistor (not shown) may be additionally coupled between the control signal voltage source V_{g} and the transistor Y_{fr}, and a resistor (not shown) may be also coupled between the gate of the transistor Y_{fr} and the power V_{nf}.

An operation of the driving circuit of FIG. 6 will be described with reference to FIG. 7. For ease of description, FIG. 7 shows a waveform where no discharge is generated. In the case that a discharge occurs, the waveform of FIG. 7 will be given such that the voltage Vₚ of the panel capacitor Cp increases in the floating period, as shown in the waveform of FIG. 4.

Referring to FIG. 7, the control signal S_{g} supplied from the control signal voltage source V_{g} alternates between a high level voltage for turning on the transistor Y_{rf}, and a low level voltage for turning off the transistor Y_{rc}.

When the control signal S_{g} has the high level voltage for turning on the transistor Y_{fr}, the charges accumulated on the panel capacitor Cₚ move to the capacitor C_{d}. As the capacitor C_{d} is charged, its first end voltage and the source voltage of the transistor Y_{fr} increase. Herein, the gate voltage of the transistor Y_{fr} may be maintained at the voltage that turned it on, but the first end voltage of the capacitor C_{d} increases. Therefore, the source voltage of the transistor Y_{fr} increases as compared to its gate voltage. When the source voltage of the transistor Y_{fr} increases to a predetermined voltage, the voltage between the gate and the source (the gate-source voltage) of the transistor Y_{fr} becomes less than the threshold voltage Vₜ of the transistor Y_{fr}, thus turning off the transistor Y_{fr}.

In other words, the transistor Y_{fr} turns off when the difference between the high level voltage of the control signal S_{g} and its source voltage is less than its threshold voltage Vₜ. When the transistor Y_{fr} turns off, the voltage supplied to the panel capacitor Cₚ is cut off, thereby floating the panel capacitor Cₚ. Consequently, the amount of charges ΔQᵢ charged in the capacitor C_{d} may be given as Equation 14. Herein, the voltage of the panel capacitor Cₚ may be immediately reduced by the predetermined voltage because the charges move immediately to the capacitor C_{d} from the panel capacitor Cₚ. Therefore, the panel capacitor Cₚ may be floated faster than the case in which the panel capacitor Cₚ is floated by controlling the level of the control signal S_{g}. Furthermore, the floating period T_{f} may be longer than the voltage applying period since the transistor Y_{fr} is still turned off when the control signal S_{g} is the low level voltage.
ΔQᵢ=C_{d}(V_{cc}−Vₜ) Equation 14

where V_{cc} is the high level voltage of the control signal S_{g}, and C_{d} is the capacitance of the capacitor C_{d}.

Additionally, the voltage variation ΔVₚᵢ of the panel capacitor Cₚ may be given as Equation 15 since the charges ΔQᵢ charged in the capacitor C_{d} are supplied from the panel capacitor Cₚ.

$$Δ {V}_{pi} = \frac{Δ {Q}_{i}}{{C}_{p}} = \frac{{C}_{d}}{{C}_{p}} ( {V}_{cc} - {V}_{t} ) \qquad Equation 15$$

When the control signal S_{g} becomes the low level, the capacitor C_{d} may be discharged through a path including the capacitor C_{d}, the diode D₁, the resistor R₁, and the control signal voltage source V_{g}, since the first end voltage of the capacitor C_{d} is higher than the control signal voltage source V_{g}. Herein, the capacitor C_{d} may be discharged in the state in which the capacitor C_{d} is charged to (V_{cc}−Vₜ) voltage, and thus the amount ΔV_{d} of the reduced voltage of the capacitor C_{d} by the discharge may be given as Equation 16.

$$Δ {V}_{d} = ( {V}_{cc} - {V}_{t} ) {ⅇ}^{- \frac{1}{{R}_{1} {C}_{d}} t} \qquad Equation 16$$

where R₁ is the resistance of the resistor R₁.

Additionally, the amount of charges ΔQ_{d} discharged from the capacitor C_{d} may be given as Equation 17 according to the low level time T_{off} of the control signal S_{g}. Therefore, the amount of charges Q_{d} remaining in the capacitor C_{d} may be given as Equation 18.

$$\begin{matrix}\begin{matrix}Δ {Q}_{d} = {C}_{d} ( {V}_{cc} - {V}_{t} ) - {C}_{d} ( {V}_{cc} - {V}_{t} ) {ⅇ}^{- \frac{1}{{R}_{1} {C}_{d}} {T}_{off}} \\ = {C}_{d} ( {V}_{cc} - {V}_{t} ) ( 1 - {ⅇ}^{- \frac{1}{{R}_{1} {C}_{d}} {T}_{off}} )\end{matrix} & Equation 17 \\ {Q}_{d} = Δ {Q}_{i} - Δ {Q}_{d} & Equation 18\end{matrix}$$

When the control signal S_{g} becomes the high level voltage again, the transistor Y_{fr} turns on and charges move from the panel capacitor Cₚ to the capacitor C_{d}. As described above, the transistor Y_{fr} turns off when the capacitor C_{d} is charged to the charges ΔQᵢ. Therefore, the transistor Y_{fr} turns off when the charges ΔQᵢ move from the panel capacitor Cₚ to the capacitor C_{d}. Consequently, the amount ΔVₚ of the reduced voltage of the panel capacitor Cₚ may be given as Equation 19.

$$Δ {V}_{p} = \frac{Δ {Q}_{d}}{{C}_{p}} = \frac{{C}_{d}}{{C}_{p}} ( {V}_{cc} - {V}_{t} ) ( 1 - {ⅇ}^{- \frac{1}{{R}_{1} {C}_{d}} {T}_{off}} ) \qquad Equation 19$$

As described above, when the voltage of the panel capacitor Cₚ decreases by ΔVₚ voltage, the voltage of the capacitor C_{d} increases so that the transistor Y_{fr} turns off. When the control signal S_{g} becomes the low level voltage, the capacitor C_{d} discharges, and the transistor Y_{fr} maintains its turned-off state. Therefore, reducing the voltage of the panel capacitor Cₚ in response to the high level control signal S_{g} and floating the panel capacitor Cₚ in response to the increase of the voltage of the capacitor C_{d} repeats. That is, reducing the voltage of the electrode and floating the electrode may be repeated.

An operation of the transistor Y_{rc} in the driving circuit of FIG. 6 will be described hereinafter. In the driving circuit of FIG. 6, when the voltage of the panel capacitor Cₚ is reduced less than a predetermined voltage, the amount of charges moved from the panel capacitor Cₚ to the capacitor C_{d} decreases, and the voltage of the capacitor C_{d} becomes less than the voltage of (V_{cc}−Vₜ). As a result, the floating period T_{off} shortens since the transistor Y_{fr} is not turned off by the voltage of the capacitor C_{d}. Additionally, the voltage discharged from the capacitor C_{d} also decreases as described in Equation 16 when the voltage of the capacitor C_{d} is less than the voltage of (V_{cc}−Vₜ). Therefore, the amount of charges moved from the panel capacitor Cₚ to the capacitor C_{d} decreases when the transistor Y_{fr} is turned on. Considering that the amount of the reduced voltage decreases at the end region of the falling waveform shown in FIG. 7, the voltage of the panel capacitor Cₚ may not be reduced to the desired voltage during the given time.

When the voltage of the panel capacitor Cₚ is lower than the predetermined voltage, and thus the amount of charges moved from the panel capacitor Cₚ to the capacitor C_{d} decreases, a signal for turning on the transistor Y_{rc} may be applied to the gate, which is a control end of the transistor Y_{rc}. Then, the transistor Y_{rc} turns on and the voltage of the capacitor C_{d} is discharged to the power V_{nf} through the transistor Y_{rc}. Therefore, the voltage of the panel capacitor Cₚ may be rapidly reduced to the desired voltage since the voltage charged in the panel capacitor Cₚ may be discharged before the transistor Y_{rc} turns on.

In the driving circuit of FIG. 6, a discharging path is formed to repeatedly reduce the voltage of the electrode and float the electrode. However, the discharging path may be removed when reducing the voltage of the electrode and floating the electrode a single time. Further, the discharging path may be formed differently. For example, the discharging path may be formed by coupling a switching element between the first end of the capacitor C_{d} and the power V_{nf}. In this case, the switching element may be turned on during the period of time T_{off} for discharging the capacitor C_{d}.

Furthermore, referring to Equation 19, the amount of the reduced voltage of the panel capacitor Cₚ may be controlled by controlling the duty ratio of the control signal S_{g}, since the reduced voltage of the panel capacitor Cₚ is determined by the resistor R₁ and the low level period T_{off} of the control signal S_{g}. The amount of the reduced voltage of the panel capacitor Cₚ may also be controlled by adjusting the resistance of a variable resistor that may be coupled to the resistor R₁ in parallel.

Additionally, a resistor may be coupled between the panel capacitor Cₚ and the transistor Y_{fr} to restrict the current discharged from the panel capacitor Cₚ. Alternatively, any other element that can restrict the current discharged from the panel capacitor Cₚ, such as an inductor (not shown), may be used instead of the resistor.

In the driving circuit of FIG. 6, the current flowing from the first end of the capacitor C_{d} to its second end is controlled by the gate-source voltage of the transistor Y_{fr} since the transistor Y_{fr} is turned off when the capacitor C_{d} is charged to the predetermined voltage. However, because a body diode may be formed in the transistor Y_{fr}, in a direction from the source to the drain, when it is a MOSFET, a current may flow from the second end of the capacitor C_{d} to its first end when the voltage of the panel capacitor Cₚ is less than a voltage of the voltage source to which the capacitor C_{d} is coupled (the voltage source is the power V_{nf} in FIG. 6). Additionally, the capacitor C_{d} may be charged continuously because there is no means for controlling this current in the driving circuit of FIG. 6. Then, the second end voltage of the capacitor C_{d} is higher than its first end voltage by the voltage charged in it. Thus, the gate voltage of the transistor Y_{fr} is higher than the first end voltage of the capacitor C_{d}, i.e., the source voltage of the transistor Y_{fr} caused by the voltage charged in the capacitor C_{d}. Consequently, the gate-source voltage of the transistor Y_{fr} may be increased by the voltage charged in the capacitor C_{d}, which may damage the transistor if this voltage is higher than its withstand voltage.

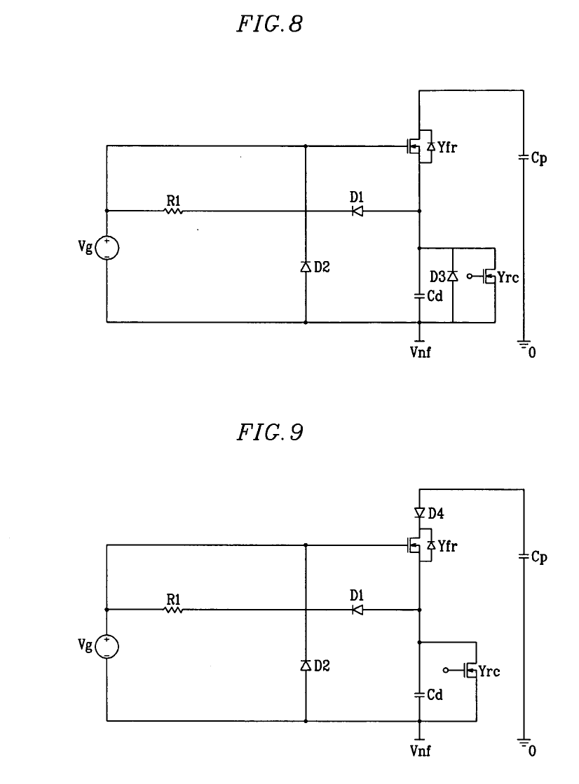

Hereinafter, a driving circuit that may prevent damage to the transistor Y_{fr} by the current flowing from the second end of the capacitor C_{d} to the first end thereof will be described with reference to FIG. 8 and FIG. 9.

FIG. 8 and FIG. 9 are schematic circuit diagrams showing the driving circuits according to second and third exemplary embodiments of the present invention, respectively. For ease of description, the body diode of the transistor Y_{fr} is shown in FIG. 8 and FIG. 9.

Referring to FIG. 8, the driving circuit of the second exemplary embodiment and the driving circuit of FIG. 6 are the same except for a diode D₃ coupled to the capacitor C_{d} in parallel. An anode of the diode D₃ may be coupled to the second end of the capacitor C_{d}, and its cathode may be coupled to the first end of the capacitor C_{d}. Then, the current generated by the body diode of the transistor Y_{fr} may flow through the diode D₃ when the second end voltage of the capacitor C_{d} is higher than the voltage of the panel capacitor Cₚ. Therefore, the capacitor C_{d} is not charged by this current. Consequently, the gate-source voltage of the transistor Y_{fr} may not exceed its withstand voltage.

Additionally, as shown in FIG. 9, the driving circuit according to the third exemplary embodiment and the driving circuit of FIG. 6 are the same except for a diode D₄ coupled between the panel capacitor Cₚ and the transistor Y_{fr}. An anode of the diode D₄ may be coupled to the first end of the panel capacitor Cₚ, and its cathode may be coupled to the drain of the transistor Y_{fr}. Then, the current that may be generated by the body diode of the transistor Y_{fr} is intercepted since the diode is formed in the opposite direction of the transistor's body diode. In FIG. 9, the diode D₄ is coupled between the panel capacitor Cₚ and the transistor Y_{fr}, but it may be formed in any position on the path including the panel capacitor Cₚ, the transistor Y_{fr}, and the capacitor C_{d}.

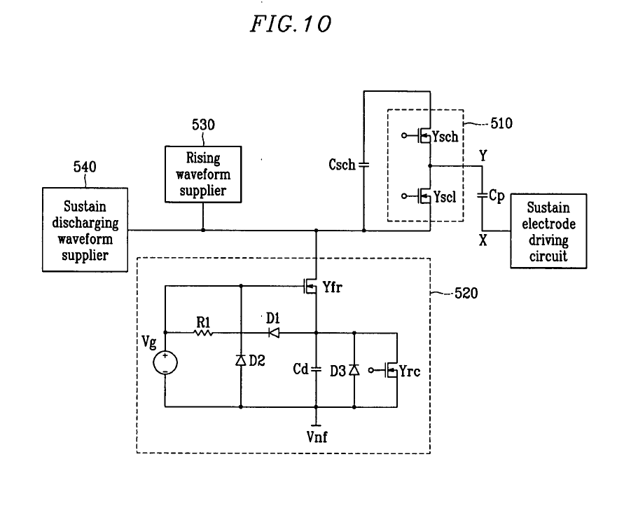

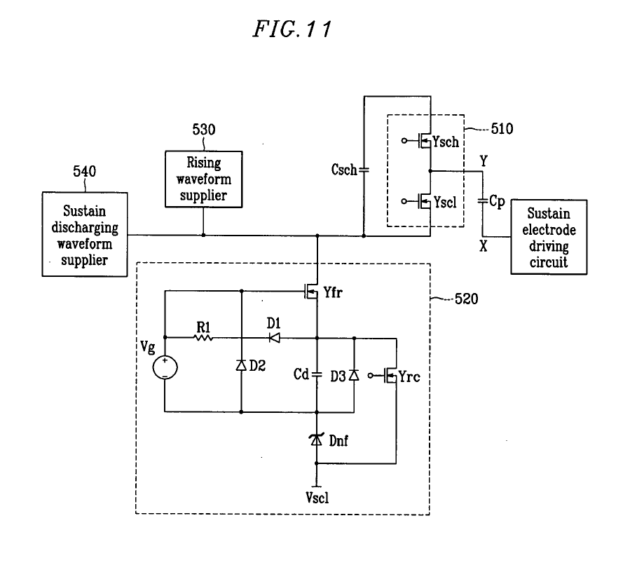

A scan electrode driving circuit for generating a falling waveform in the falling period Pr₂ of the reset period Pᵣ, that may use the driving circuits described in the first to third exemplary embodiments of the present invention, will be described hereinafter with reference to FIG. 10 and FIG. 11. FIG. 10 and FIG. 11 show a scan electrode driving circuit according to fourth and fifth exemplary embodiments of the present invention, respectively.

Typically, a selecting circuit 510 is coupled as an integrated circuit to the respective scan electrodes Y1 to Yn so as to sequentially select the scan electrodes Y1 to Yn during the address period. FIG. 10 and FIG. 11 show one Y electrode and one selecting circuit 510, for ease of description. Further, the panel capacitor Cₚ is a capacitive load between the Y electrode and the X electrode, which is adjacent to the Y electrode. Additionally, a sustain electrode driving circuit is coupled to the X electrode.

Referring to FIG. 10, the scan electrode driving circuit according to the fourth exemplary embodiment of the present invention may include a selecting circuit 510, a capacitor C_{sch}, a falling waveform supplier 520, a rising waveform supplier 530, and a sustain discharging waveform supplier 540. The capacitor C_{sch} is charged with the voltage of V_{sch}, and it may be charged by a power (not shown) coupled to its first end.

The selecting circuit 510 may include two transistors Y_{sch} and Y_{scl}, and a body diode may be formed in each of these transistors in the direction from the source to the drain. The source of the transistor Y_{sch} and the drain of the transistor Y_{scl} may be coupled to the Y electrode of the panel capacitor Cp. The first end of the capacitor C_{sch} may be coupled to the drain of the transistor Y_{sch}, and a second end of the capacitor C_{sch} may be coupled to the source of the transistor Y_{scl}. Further, the source of the transistor Y_{scl} may be coupled with the falling waveform supplier 520, the rising waveform supplier 530, and the sustain discharging waveform supplier 540.

The falling waveform supplier 520 supplies a falling waveform to the Y electrode during the falling period Pr₂ of the reset period Pᵣ of FIG. 3. The driving circuit of FIG. 6, FIG. 8, and FIG. 9 may be applied thereto. In FIG. 10, the driving circuit of FIG. 8 is used for the falling waveform supplier 520. The rising waveform supplier 530 supplies a rising waveform to the Y electrode during the rising period Pᵣ₁ of the reset period Pᵣ, and a circuit supplying a rising voltage in a typical ramp shape may be used therefor. The sustain discharging waveform supplier 540 supplies a sustain discharging waveform to the Y electrode during the sustain period Pₛ of FIG. 3.

A method of supplying voltages to the Y electrode during the address period Pₐ of FIG. 3 will be described hereinafter, assuming that the selecting voltage V_{scl} and the final voltage V_{nf} of the falling period Pr₂ are equal.

The transistors Y_{fr}, Y_{rc}, and Y_{sch} are turned on and the transistor Y_{scl} is turned off when the Y electrode is not selected, thereby applying a voltage of V_{sch} through the transistor Y_{sch}. That is, the Y electrode that is not selected may be biased at the voltage of V_{sch}.

To select the Y electrode, the transistor Y_{sch} turns off, and the transistor Y_{scl} turns on while the transistors Y_{fr} and Y_{rc} are on. Then, the voltage at the Y electrode decreases to the voltage of V_{nf} through the transistor Y_{scl}. In other words, the selecting voltage V_{nf} is applied to the selected Y electrode, as shown in FIG. 3, assuming that V_{scl} equals V_{nf}. When selecting another Y electrode, the transistor Y_{sch} turns on and the transistor Y_{scl} turns off, thus biasing the Y electrode at the voltage of V_{sch}.

According to the fourth exemplary embodiment of the present invention, the falling waveform supplier 520 may apply the selecting voltage in the address period to the Y electrode. Accordingly, a transistor for supplying the selecting voltage may be removed.

Further, while the selecting voltage in the address period Pₐ and the final voltage V_{nf} of the falling period Pr2 are assumed to be the same in the fourth exemplary embodiment, the selecting voltage V_{scl} may be less than the final voltage V_{nf}.

Referring to FIG. 11, a falling waveform supplier 520 according to the fifth exemplary embodiment of the present invention may include what the falling waveform supplier 520 shown in FIG. 10 includes, and it may further include a zener diode D_{nf}. In this case, the second end of the capacitor C_{d} may be coupled to a cathode of the zener diode D_{nf}, and an anode of the zener diode D_{nf} may be coupled to a power supplying the selecting voltage V_{scl}. It is assumed that a breakdown voltage V_{z} of the zener diode D_{nf} is a voltage (V_{nf}−V_{scl}), which is the difference between the final voltage V_{nf} and the selecting voltage V_{scl}. In this way, the transistors Y_{fr} and Y_{rc} are turned on during the address period Pₐ to transmit the selecting voltage V_{scl}. The voltage at the second end of the capacitor C_{d} substantially becomes the voltage of V_{nf} by the zener diode D_{nf} in the falling period Pr₂ of the reset period Pᵣ, and therefore a final voltage in the falling period Pr₂ may be the voltage of V_{nf}. Further, the transistor Y_{rc} may be turned on to discharge the capacitor C_{d} through a path including the capacitor C_{d}, the transistor Y_{rc}, and the zener diode D_{nf}, in the latter part of the falling period Pᵣ₂.

The scan electrode driving circuits of FIG. 10 and FIG. 11 use the transistor that supplies the falling waveform to supply the selecting voltage, according to the exemplary embodiments of the present invention. Further, the present invention may be applicable in a case that the falling waveform supplier 520 gradually reduces the voltage of the scan electrode without using a driver generating ramp waveforms.

According to exemplary embodiments of the present invention, the wall charges may be quickly and stably erased in the reset period, and the number of transistors may be reduced by using the transistor used in the reset period again in the address period.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A driving apparatus of a plasma display panel having a capacitive load formed by at least two electrodes, comprising:
a first transistor having a first main end coupled to a first electrode of the capacitive load;
a capacitor having a first end coupled to a second main end of the first transistor and a second end coupled to a first power supplying a first voltage; and
a second transistor coupled between the second main end of the first transistor and a second power supplying a second voltage,
wherein the capacitor receives charges from the capacitive load when the first transistor turns on;
wherein a voltage at the first electrode is reduced by repeating a process of turning on and turning off the first transistor during a reset period; and
wherein the first transistor and the second transistor turn on during an address period to apply the second voltage to the first electrode.

2. The driving apparatus of claim 1, wherein the voltage at the first electrode is reduced due to the charges moving from the capacitive load to the capacitor when the first transistor turns on, and the first transistor turns off when a predetermined amount of charges moves to the capacitor.

3. The driving apparatus of claim 2,
wherein the first transistor turns off due to a difference between a second main end voltage and a control end voltage of the first transistor; and
wherein the difference is caused by the predetermined amount of charges moved to the capacitor.

4. The driving apparatus of claim 2, further comprising a discharge path for discharging at least a portion of the predetermined amount of charges charged in the capacitor.

5. The driving apparatus of claim 4, wherein charges move from the capacitive load to the capacitor when the first transistor turns on after the capacitor is discharged.

6. The driving apparatus of claim 4,
wherein a control signal having a first level and a second level is applied to a control end of the first transistor;
wherein the first transistor turns on in response to the first level; and
wherein the discharge path forms in response to the second level.

7. The driving apparatus of claim 6, wherein the control signal is supplied by a control signal voltage source coupled between the control end of the first transistor and the second end of the capacitor.

8. The driving apparatus of claim 4, wherein the discharge path comprises a resistor and a diode interrupting a current flowing in a direction for charging the capacitor.

9. The driving apparatus of claim 1, further comprising a diode formed in a direction for interrupting the current that has passed through a body diode of the first transistor flowing to the capacitor.

10. The driving apparatus of claim 9, wherein an anode of the diode is coupled to the second end of the capacitor and a cathode of the diode is coupled to the first end of the capacitor.

11. The driving apparatus of claim 9, wherein an anode of the diode is coupled to the first electrode and a cathode of the diode is coupled to the first main end of the first transistor.

12. The driving apparatus of claim 1, wherein the first voltage and the second voltage are the same.

13. The driving apparatus of claim 1, further comprising:
a zener diode coupled between the second end of the capacitor and the second power,
wherein the first voltage is a sum of the second voltage and a breakdown voltage of the zener diode.

14. The driving apparatus of claim 1,
wherein during the reset period, the second transistor is turned on when the voltage at the first electrode is reduced to a third voltage; and
wherein the third voltage is higher than the first voltage.

15. The driving apparatus of claim 1, further comprising:
a second capacitor;
a third transistor; and
a fourth transistor,
wherein the first main end of the first transistor is coupled to a node of a second end of the second capacitor and a source electrode of the third transistor;
wherein a first end of the second capacitor is coupled to a drain electrode of the fourth transistor; and
wherein the first electrode of the capacitive load is coupled to a source electrode of the fourth transistor and a drain electrode of the third transistor.

16. A driving apparatus of a plasma display panel having a capacitive load formed by at least two electrodes, comprising:
a first transistor having a first main end coupled to a first electrode of the capacitive load;
a driver coupled between a control end and a second main end of the first transistor and a first power supplying a first voltage; and
a second transistor coupled between the second main end of the first transistor and a second power supplying a second voltage,
wherein the driver controls an operation of the first transistor to gradually reduce a voltage at the first electrode during a reset period;
wherein the second voltage is supplied to the first electrode when the first transistor and the second transistor are turned on during an address period.

17. The driving apparatus of claim 16, wherein the driver repeatedly turns on the first transistor to reduce the voltage at the first electrode and turns off the first transistor to float the first electrode to gradually reduce the voltage at the first electrode.

18. The driving apparatus of claim 16, further comprising:
a zener diode coupled between the driver and the second power,
wherein the first voltage is a sum of the second voltage and a breakdown voltage of the zener diode.

19. The driver apparatus of claim 16,
wherein during the reset period, the second transistor is turned on when the voltage at the first electrode is reduced to a third voltage; and
wherein the third voltage is higher than the first voltage.
